(19) United States
(12) Patent Application Publication
(10) Pub. No.: US 2005/0191122 A1
(43) Pub. Date: Sep. 1, 2005

(54) Locking mechanism for a threaded connection

(76) Inventor: Douglas P. Gethmann, Gladbrook, IA (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/790,524

(22) Filed: Mar. 1, 2004

(51) Int. Cl. F16B 1/00; F16B 7/18

(52) U.S. Cl. 403/320; 411/512

(57) ABSTRACT

A locking mechanism for securing a female member defining a threaded aperture to a male member having a threaded insertion end sized to threadably engage the female member threaded aperture has a body extending along an axis. The body defines an outer side surface sized for insertion into the female member threaded aperture and first and second axial ends. A wedge projects from the first axial end of the body and has an inner engagement surface adapted to engage the insertion end of the male member and an outer engagement surface adapted to engage the threaded aperture of the female member. The wedge is sufficiently pliant to deflect radially outward in response to an insertion force applied to the male member.

### FIELD OF THE DISCLOSURE

The present disclosure generally relates to apparatus for locking a threaded connection against rotation.

### BACKGROUND OF THE DISCLOSURE

In many applications, it is common to provide a locking mechanism for a threaded connection to prevent one member from rotating relative to the other. The connection between a control valve and actuator, for example, typically requires such a locking mechanism. The control valve may have a sliding stem that is connected at one end to a throttling element disposed in the valve body. The actuator may have a rod capable of being reciprocated in opposite directions. The valve stem may be coupled to the actuator rod so that movement of the actuator positions the throttling element within the valve body.

While the stem may be connected directly to the actuator rod in many standard applications, in certain applications it is desirable to indirectly couple the actuator rod to the valve stem. For example, the actuator may need to be spaced an additional distance from the valve, such as when the valve is used in a high-temperature application or where a bellows is required between the valve and the actuator to retain toxic fluids that may be passing through the valve. In these types of applications, an extension stem is often used to connect the valve stem to the actuator rod so that standard valve stem and actuator rod lengths may be used. The extension stem has threaded ends for coupling with the complementary threads provided on the valve stem and actuator rod. Accordingly, where the valve stem is formed with external threads, a first end of the extension stem is formed with complimentary internal threads. Similarly, where the actuator rod is formed with internal threads, an opposite end of the extension stem is formed with complimentary external threads.

Various conventional locking mechanisms are known for preventing inadvertent rotation of the valve stem. For example, lock nuts, lock washers, and clamps are often used to secure the valve stem against rotation. While the conventional locking mechanisms adequately secure the valve stem and actuator rod against rotation, they are not suitable for applications in which access to the ends of the extension stem is limited. These conventional locking mechanisms require sufficient clearance around the ends of the extension stem to allow insertion and use of a tightening tool, such as a wrench. The area in which the valve is located, however, may have insufficient access space for such tools. In addition, conventional locking mechanisms typically comprise multiple parts requiring several assembly steps, and therefore are overly difficult and burdensome to assemble.

### BRIEF DESCRIPTION OF THE DRAWINGS

FIG. 1 is a schematic representation, partially in cross-section, of a valve stem and actuator rod connected by an extension stem;

FIG. 2 is a side elevation view, in cross-section, of a detail from FIG. 1 showing a locking mechanism for securing valve stem to the actuator rod in accordance with the present disclosure; and

FIGS. 3A and 3B, respectively, are a top view and a side view elevation view, in cross-section, of the locking mechanism shown in FIG. 2.

### DETAILED DESCRIPTION

The present disclosure is directed to a locking mechanism for securing components connected by a threaded engagement against relative rotation. The locking mechanism is described herein in conjunction with the connection between a control valve and an actuator. This is but one of the many applications in which the locking mechanism may be used, as it has general applicability to any type of threaded connection between components where it is desirable to prevent rotation of one component with respect to the other.

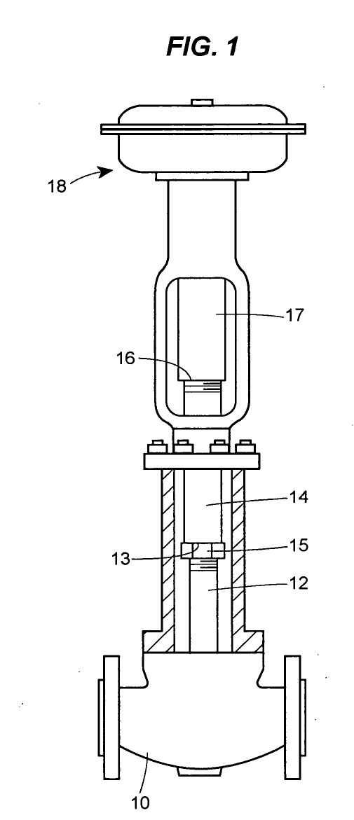

FIG. 1 illustrates a control valve environment in which the locking mechanism may be used. A control valve 10 is provided for controlling fluid flow through a conduit (not shown). The control valve includes a sliding valve stem 12 which is connected at one end to a throttling element (not shown) disposed in the valve. An opposite end of the valve stem 12 is connected to an extension stem 14. In the illustrated embodiment, the lower end 13 of the extension stem 14 is formed with internal threads for receiving external threads formed on the valve stem 12. The connection between the extension stem 14 and valve stem 12 may be secured by a conventional stem connector, such as the illustrated lock washer 15, or by a locking mechanism in accordance with the present disclosure, as described in greater detail below. An upper or insertion end 16 of the extension stem 14 is connected to a rod 17 of an actuator 18. In the illustrated embodiment, the actuator rod 17 is formed with internal threads that mate with external threads formed on the upper end 16 of the extension stem 14. An extension bonnet 19, shown in cross-section for clarity, extends between the control valve 10 and the actuator 18. The extension bonnet 19 is longer than a standard bonnet to create additional space between the valve 10 and actuator 18, which may be required to protect the actuator from the process fluid conditions, such as applications involving high heat or toxic fluids.

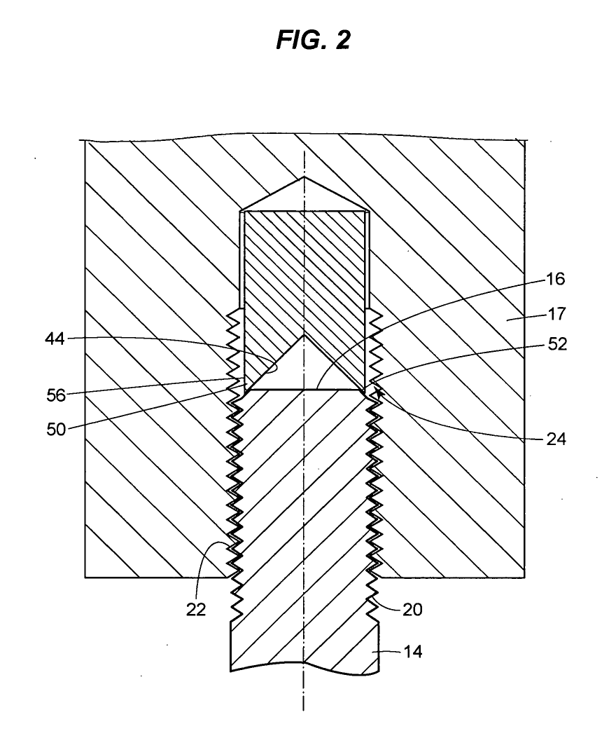

The connection between the extension stem 14 and actuator rod 17 is illustrated in greater detail in FIG. 2. The upper end 16 of the extension stem 14 is shown having external threads 20, and therefore may be considered to be a first or male connection member. Conversely, the actuator rod 17 is formed with internal threads 22 which compliment the external threads 20, and therefore the actuator rod 17 may be considered a second or female connection member. The internal threads 22 define a threaded aperture 24 formed in the actuator rod 17.

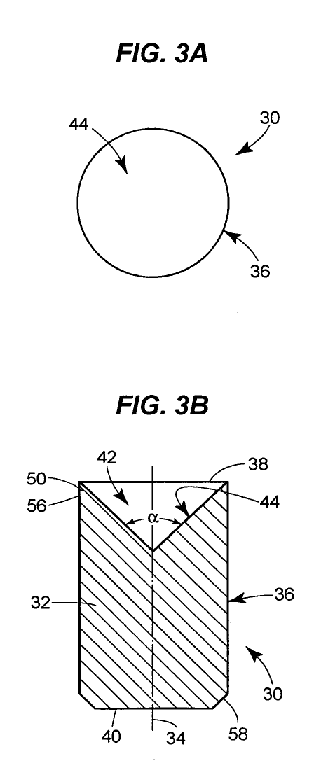

A locking mechanism 30 is provided for securing the extension stem 14 against rotation relative to actuator rod 17. As best illustrated in FIGS. 3A and 3B, the locking mechanism 30 has a main body 32 extending along an axis 34. The main body 32 is sized for insertion into the threaded aperture 24 of the actuator rod 17 and may define a generally cylindrical side surface 36. The main body 32 also defines a first and second axial ends 38, 40.

The locking member 30 includes a wedge 50 for engaging both the extension stem 14 and the actuator rod 17 to create friction forces which prevent rotation of the extension stem 14 relative to the actuator rod 17. In the illustrated embodiment, the wedge is formed as a rim having a triangular cross-section extending continuously around the first axial end 38 of the main body 32. It will be appreciated, however, that the wedge 50 may be formed with other cross-sectional shapes that extend either continuously or intermittently around the first axial end 38.

The wedge 50 defines inner and outer engagement surfaces for engaging the extension stem 14 and actuator rod 17, respectively. As best shown in FIG. 2, the wedge includes a first or inner engagement surface 44 formed in the first axial end 38 of the main body 32. The inner engagement surface may be shaped to complement that of a tip portion of the extension stem insertion end 16. In the illustrated embodiment, the tip portion of the insertion end 16 is formed with a chamfer, and the inner engagement surface 44 is oriented as substantially the same angle as the chamfer. The wedge further defines a second or outer engagement surface 54 for engaging the actuator rod 17. As illustrated, the outer engagement surface 56 is coincident with the side surface 32 of the main body 32. The wedge 50, by its structure or material, is sufficiently pliant to deform in response to an axial insertion force exerted on the inner engagement surface 44, as described in greater detail below. The insertion force may be any force used to thread the extension stem 14 into the actuator rod 17, such as a torque applied to the extension stem 14.

The wedge 50 may be conveniently formed in the main body 32 by forming a cavity 42 in a central portion of the first axial end 38. While the cavity 42 is illustrated as having a cone shape, it will be appreciated that the cavity 42 may be formed with other shapes. Furthermore, while the cavity 42 cone shaped cavity 42 preferably has a vertex angle “\acute{α}” of approximately 120°, the vertex angle may be formed at any other angle.

During assembly, the locking mechanism 30 is inserted into the threaded aperture 24 of the actuator rod 17 such that the cavity 42 is exposed toward the opening of the aperture. The extension stem 14 may then be threaded into the aperture 24 until a tip portion 52 engages the engagement surface 44 of the locking mechanism 30. After engagement with the locking mechanism 30, an additional insertion force will further rotate the extension stem 14 into the threaded aperture 24, causing the wedge 50 to deflect outwardly and into engagement with the female threads 22. As a result, a first friction force is generated between the tip portion 52 of the extension stem 14 and the engagement surface 44 of the locking mechanism 30 while a second friction force is generated between the outer engagement surface 54 and the female threads 22 of the actuator rod 17. The first and second friction forces are greater than the friction force generated by a standard threaded connection, and serve to hold the extension stem 14 against rotation relative to the actuator rod 17. Furthermore, the first and second friction forces increase as the torque applied to the extension stem 14 increases.

While the insertion force is described herein as being applied to the extension stem 14, that force need not be directly applied to the extension stem. Instead, it may be a resultant force from an initial force applied to the actuator rod 17, valve stem 12, or other component.

As best shown in FIG. 3B, the second axial end 40 of the main body 32 may be formed to assist in centering the locking mechanism 30 inside the threaded aperture 24. In the illustrated embodiment, an annular chamfer 58 is formed at the second axial end 40.

The material for the locking mechanism 30 may be selected to enhance the friction forces generated with the extension stem 14 and actuator rod 17. Certain steels, such as the 300 series stainless steels, are prone to galling, during excessive friction between two components results in localized welding. Accordingly, galling may be promoted if the locking mechanism, extension stem 14, and actuator rod 17 are all formed of the same material, such as an austenitic stainless steel (like 316 stainless steel) or an annealed carbon steel, thereby increasing the locking force applied between the locking mechanism 30 and the stem 14 and rod 17, respectively. Alternatively, galling may be promoted when the locking mechanism material is selected to have similar strength and hardness properties as the stem 14 and actuator rod 17 materials, and therefore the locking mechanism material need not exactly match the stem and rod materials to produce the galling effect. Still further, the locking mechanism material may be selected for other desired qualities, such as corrosion resistance, as may be desirable for the particular application.

From the foregoing, it will be appreciated that a locking mechanism is disclosed herein which may be fully contained within a threaded aperture, and therefore requires no additional external space for assembly. The locking mechanism does not require additional assembly other than insertion of the locking mechanism into the threaded aperture, as is engages the connection members as they are tightened. In addition, the wedge may plastically deform in response to the insertion force so that the locking mechanism is retained in the threaded aperture even after the male connection member is withdrawn, thereby simplifying reassembly.

Although the certain apparatus constructed in accordance with the teachings of this disclosure have been described herein, the scope of coverage of the patent is not limited thereto. On the contrary, this patent covers all apparatuses, methods, and articles of manufacture of the teachings of the invention fairly falling within the scope of the appended claims either literally or under the doctrine of equivalents.

1. A locking mechanism for securing a female member to a male member, wherein the female member defines a threaded aperture and the male member has a threaded insertion end sized to threadably engage the female member threaded aperture, the locking mechanism comprising:
a body extending along an axis and having an outer side surface sized for insertion into the female member threaded aperture, the body defining first and second axial ends; and
a wedge projecting from the first axial end of the body, the wedge having an inner engagement surface adapted to engage the insertion end of the male member and an outer engagement surface adapted to engage the threaded aperture of the female member, the wedge being sufficiently pliant to deflect radially outward in response to an insertion force applied to the male member.

2. The locking mechanism of claim 1, in which the wedge forms a continuous rim extending around the body first axial end.

3. The locking mechanism of claim 1, in which a central portion of the body first axial end defines a cavity that forms the inner engagement surface of the wedge.

4. The locking mechanism of claim 3, in which the cavity has a cone shape.

5. The locking mechanism of claim 4, in which the cone has a vertex angle of approximately 120 degrees.

6. The locking mechanism of claim 1, in which the wedge deforms radially outward as the insertion force is applied to the male member.

7. The locking mechanism of claim 1, in which the locking mechanism is formed of a material having a similar hardness and strength as the male and female members.

8. The locking mechanism of claim 1, in which the locking mechanism is formed of a 300 series stainless steel.

9. A locking assembly comprising:
a first connection member defining an insertion end formed with male threads;
a second connection member defining an aperture formed with female threads complementary to the male threads; and
a locking mechanism having a body extending along an axis, the body defining a generally cylindrical outer side surface sized for insertion into the aperture of the second connection member and having first and second axial ends, a wedge projecting from the first axial end of the body, the wedge having an inner engagement surface adapted to engage the insertion end of the first connection member and an outer engagement surface adapted to engage the threaded aperture of the second connection member, the wedge being sufficiently pliant to deflect radially outward in response to an insertion force applied to the first connection member;
wherein, as the male threads of the first connection member are threadably engaged with the female threads of the second connection member by the insertion force, the inner engagement surface engages the insertion end of the first connection member to generate a first friction force between the locking mechanism and the first connection member and the wedge deflects outward so that the outer engagement surface engages the female threads of the second connection member to generate a second friction force between the locking mechanism and the second connection member.

10. The locking assembly of claim 9, in which the first connection member comprises an extension stem and the second connection member comprises a valve actuator rod.

11. The locking assembly of claim 9, in which the wedge forms a continuous rim extending around the body first axial end.

12. The locking assembly of claim 9, in which a central portion of the body first axial end defines a cavity that forms the inner engagement surface of the wedge.

13. The locking assembly of claim 12, in which the cavity has a cone shape.

14. The locking assembly of claim 13, in which the cone has a vertex angle of approximately 120 degrees.

15. The locking assembly of claim 9, in which the locking mechanism, first connection member, and second connection member are all formed of materials having similar hardness and strength.

16. The locking mechanism of claim 15, in which the locking mechanism, first connection member, and second connection member are all formed of a 300 series stainless steel.

17. A locking mechanism for securing a valve actuator rod to an extension stem, wherein the valve actuator rod defines a threaded aperture and the extension stem has a threaded insertion end sized to threadably engage the threaded aperture, the locking mechanism comprising:
a body extending along an axis and having a generally cylindrical outer side surface sized for insertion into the threaded aperture of the valve actuator rod, the body defining first and second axial ends; and
a wedge projecting from the first axial end of the body, the wedge having an inner engagement surface adapted to engage the insertion end of the extension stem and an outer engagement surface adapted to engage the threaded aperture of the valve actuator rod, the wedge being sufficiently pliant to deflect radially outward in response to an insertion force applied to the extension stem.

18. The locking mechanism of claim 17, in which the wedge forms a continuous rim extending around the body first axial end.

19. The locking mechanism of claim 17, in which a central portion of the body first axial end defines a cavity that forms the inner engagement surface of the wedge.

20. The locking mechanism of claim 19, in which the cavity has a cone shape.

21. The locking mechanism of claim 20, in which the cone has a vertex angle of approximately 120 degrees.

22. The locking mechanism of claim 17, in which the wedge deforms radially outward as the insertion force is applied to the male member.
